(19) United States
(12) Patent Application Publication
(10) Pub. No.: US 2026/0206063 A1
(43) Pub. Date: Jul. 16, 2026

(54) Managing Connection of Wireless Devices to a Communication Network

(71) Applicants: Tanguy Kerdoncuff, Ermont (FR); Adrian Garcia Rodriguez, Paris (FR); Nizar Kheir, Gif sure Yvette (FR)

(72) Inventors: Tanguy Kerdoncuff, Ermont (FR); Adrian Garcia Rodriguez, Paris (FR); Nizar Kheir, Gif sure Yvette (FR)

(21) Appl. No.: 19/110,548

(22) PCT Filed: Oct. 4, 2022
(86) PCT No.: PCT/EP2022/077594

§ 371 Date: Mar. 11, 2025

(51) Int. Cl. H04W 74/0833; H04L 41/16; H04W 28/06; H04W 76/10; H04W 76/20

(52) U.S. Cl. CPC H04W 74/0833; H04L 41/16; H04W 28/06; H04W 76/10; H04W 76/20

(57) ABSTRACT

A method (300) is disclosed for managing connection of wireless devices to a communication network. The method is performed by a RAN node of the communication network and comprises receiving a Radio Resource Connection (RRC) connection REQUEST message from a wireless device during an RRC connection establishment procedure (310), and, if a trigger condition is fulfilled (320), extracting Layer 1 features from signals on which at least one of the RRC connection REQUEST message or a Physical Random Access Channel (PRACH) transmission were received from the wireless device (330). The features are at least partially representative of the physical location of the wireless device at a time of signal transmission. The method further comprises comparing the extracted Layer 1 features with reference features (340), and, if a separation between the extracted features and at least some of the reference features is below a connection threshold value (350), restricting an availability of connection to the communication network for the wireless device (360). The reference features comprise Layer 1 that were extracted from signals on which at least one of an RRC connection REQUEST message or a PRACH transmission were received during at least one previous, uncompleted, RRC connection establishment procedure.

### TECHNICAL FIELD

The present disclosure relates to a method for managing connection of wireless devices to a communication network, the communication network comprising a Radio Access Network (RAN). The method is performed by a RAN node of the communication network, and the present disclosure also relates to a RAN node, and to a computer program product configured, when run on a computer, to carry out a method for managing connection of wireless devices to a communication network.

### BACKGROUND

The Radio Resource Control (RRC) protocol is a Layer 3 protocol used over the air interface between User Equipments (UEs) and Base Stations in both UMTS (3G), LTE (4G), and NR (5G) telecommunication networks. This protocol is an integral part of the 3GPP specification, specified by 3GPP in TS 25.331 for UMTS, TS 36.331 for LTE, and TS 38.331 for NR. The main functions of the RRC protocol include connection establishment, connection release, radio bearer establishment, mobility procedures, broadcast of system information, etc.

Operation of the RRC protocol is guided by a state machine which defines the specific state of a UE. The RRC States offer a seamless way to manage system access, power saving, and mobility optimization in telecommunication networks. In the RRC NR specification (TS 38.331), the UE can be in one of the following three RRC states:
NR-RRC Connected: An RRC context is established between the UE and the Network, which means that all parameters necessary for communication are known to both nodes. The mobility is controlled by the Network.
NR-RRC Idle: An RRC context is not established between the UE and the Network.
NR-RRC Inactive: An RRC context is established between the UE and the Network, but the mobility is controlled by the UE.

A dedicated procedure called the “RRC connection establishment procedure” enables UEs to exchange messages with the base station. The RRC connection establishment procedure is initiated by the UE, which leaves the idle mode and sends an RRC CONNECTION REQUEST message to the base station. The general outline of the RRC establishment procedure is illustrated in FIG. 1, and it enables the establishment of Layer 1 (Physical) and Layer 2 (MAC) channels between the UE and the Radio Access Network (RAN).

A key functionality for the RRC connection establishment procedure is to enable UEs that are not registered nor connected to the network to start a signaling session in which a dedicated radio channel is allocated to those devices. To facilitate UE contention resolution during the transmission of the Physical Random Access Channel (PRACH) preamble, the 3GPP specification requires a UE to send an initial UE identity as a message parameter with the RRC Connection Request. This parameter can be either a Serving Temporary Mobile Subscriber Identity (S-TMSI) or a bit string of random value. It will be appreciated that such initial UE identity cannot serve to identify a UE uniquely over the network, as this is a parameter that is set only by the UE, without prior control or verification by the network.

The RRC Connection establishment procedure provides means for unconnected and unregistered devices to start a new signaling session and register with the network. A device can be unregistered because it was turned-off, or in standby mode, or because it is a new device connecting to the network. This procedure occurs before the UE is authenticated, and the network must always assign a dedicated radio channel to the UE before sending the RRC Connection Setup message (as illustrated in FIG. 1) so that it can start the registration and security session establishment. This fundamental property opens the door for so-called Signaling Denial-of-Service (DoS) attacks in which a set of malicious, hijacked, or compromised devices may try to exhaust available network resources needed to access the network. When this occurs, the network may no longer be able to start the Connection Setup process for benign UEs.

As illustrated in FIG. 2, three RRC signaling DoS attack variants can be identified, distinguished by the point within the RRC Connection establishment procedure at which the attack occurs.

In a first variant, the RRC signaling DoS attack involves a set of malicious UEs in RRC Idle that, after receiving an RRC Connection SETUP message from the base station (as illustrated in FIG. 1), will continue to send the RRC Connection REQUEST message, without responding to the network with the RRC Connection SETUP COMPLETE message. In an example attack procedure, this behavior can be triggered by a set of malicious UEs within a cell. If each malicious UE sends a sufficiently high number of RRC Connection REQUEST messages, the pool of resources dedicated by the base station to this connection setup procedure may be exhausted.

In a second variant, the malicious UEs in RRC Idle send the RRC Connection SETUP COMPLETE message to the base station. After sending this message, the malicious UE may then trigger the Non-Access Stratum (NAS) Registration procedure with the Access and Mobility Management Function (AMF) in the 5G core network. The AMF function will then answer with the NAS Identity Request to identify the new connecting UE. The malicious UE will not answer with the NAS Identity Response message to the AMF, keeping the radio channel suspended until the timeout timer has expired.

In a third variant, hijacked UEs act together to trigger a signaling attack. Hijacked UEs here comprise a set of benign UEs who are allowed to access the network (i.e., with valid identifiers previously obtained) but which have been compromised by an attacker and driven to trigger a signaling DoS attack over the radio interface. In that situation, the compromised UEs may have the same behavior as in the two previous variants. Alternatively, the compromised UEs may also send the NAS Identity Response (sending their TIMSI identifier in LTE or Subscription Concealed Identifier (SUCI) identifier in NR), but then do not send the RRC NAS authentication RESPONSE.

Each of the above-described DoS attack variants results in a situation in which network resources available for the RRC connection setup procedure are exhausted, meaning legitimate UEs will no longer be able to execute the RRC connection setup procedure and transition to the connected state.

Various techniques exist to try to counter Signaling DoS attacks. Such techniques may be classified as Current state of the art techniques to counter Signaling DoS attacks may be classified into techniques seeking to counter signaling attacks by registered malicious UEs, and techniques seeking to counter signaling attacks using hijacked UE identifiers.

RRC signaling attacks against the core network leverage design flaws in the RRC state machine to trigger excessive signaling between malicious UEs and the core network functions (e.g., Mobility Management Entity (MME) in LTE, AMF in NR). The aim of these attacks is either to overload a core network function and deplete its resources, or alternatively to deplete all available radio bearers within a target cell.

Current techniques for detecting these attacks mainly rely on statistical or machine learning models, and aim to develop mathematical models for a mobile user's signaling behavior (categorizing a user as being either benign or malicious according to its behavior). These models serve to pinpoint suspect or malicious UEs that are engaged in an RRC signaling storm attack. Mitigation of such attacks in the current state of the art is done through tuning inactivity timers depending on the network context and observed attacks, or preventing suspect UEs from accessing or keeping available radio bearers over specific period of times. A key limitation of these approaches is that they can be used only after the UE has been registered and connected to the network. After registration, the UE is authenticated and uniquely identified to the network. This enables the building of a behavioral model for each device, which model can be used to detect malicious UEs. However, during the RRC Connection Establishment procedure, the UE is not yet authenticated and uniquely identified in the network, meaning techniques based on behavior modeling cannot be used to counter Signaling DoS attacks of the type described above, that target RRC Connection Establishment procedure itself.

Considering RRC signaling attacks using hijacked UE identifiers, the hijacking of UE identifiers can be carried out using state-of-the-art attack techniques like International Mobile Subscriber Identity (IMSI) catcher attacks. After an attacker has gathered a suitably large number of hijacked UE identifiers, the attacker may use the hijacked identifiers to trigger an RRC signaling attack. In the context of NR, this may involve the third attack variant discussed above. In order to counter such attacks, the network can use the valid identifiers that have been hijacked to build behavioral profiles for each identified UE, and so to detect specific malicious UEs and limit the radio resources allocated to those UEs. However, such techniques suffer from the limitation discussed above that they can be used only after the hijacked UE has been authenticated and uniquely identified in the network, and cannot be used to counter Signaling DoS attacks that target the RRC Connection Establishment procedure.

### SUMMARY

It is an aim of the present disclosure to provide methods, a RAN node, and a computer program product which at least partially address one or more of the challenges mentioned above. It is a further aim of the present disclosure to provide methods, a RAN node, and a computer program product which facilitate detection of Signalling SoS attacks that target the RRC Connection Establishment procedure.

According to a first aspect of the present disclosure, there is provided a method for managing connection of wireless devices to a communication network, the communication network comprising a RAN. The method is performed by a RAN node of the communication network, and comprises receiving an RRC connection REQUEST message from a wireless device during an RRC connection establishment procedure. The method further comprises, if a trigger condition is fulfilled, extracting Layer 1 features, which features are at least partially representative of the physical location of the wireless device at a time of signal transmission, from signals on which at least one of the RRC connection REQUEST message or a PRACH transmission were received from the wireless device. The method further comprises comparing the extracted Layer 1 features with reference features, and, if a separation between the extracted features and at least some of the reference features is below a connection threshold value, restricting an availability of connection to the communication network for the wireless device. For the purposes of the method, the reference features comprise Layer 1 features, which features are at least partially representative of the physical location of a wireless device at a time of signal transmission, and were extracted from signals on which at least one of an RRC connection REQUEST message or a PRACH transmission were received during at least one previous, uncompleted, RRC connection establishment procedure.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a RAN node for managing connection of wireless devices to a communication network, wherein the communication network comprises a RAN. The RAN node comprises processing circuitry configured to cause the RAN node to receive an RRC connection REQUEST message from a wireless device during an RRC connection establishment procedure. The processing circuitry is further configured to cause the RAN node, if a trigger condition is fulfilled, to extract Layer 1 features, which features are at least partially representative of the physical location of the wireless device at a time of signal transmission, from signals on which at least one of the RRC connection REQUEST message or a PRACH transmission were received from the wireless device. The processing circuitry is further configured to cause the RAN node to compare the extracted Layer 1 features with reference features, and, if a separation between the extracted features and at least some of the reference features is below a connection threshold value, to restrict an availability of connection to the communication network for the wireless device. The reference features comprise Layer 1 features, which features are at least partially representative of the physical location of a wireless device at a time of signal transmission, and were extracted from signals on which at least one of an RRC connection REQUEST message or a PRACH transmission were received during at least one previous, uncompleted, RRC connection establishment procedure.

Aspects of the present disclosure thus provide methods and nodes that address the three Signaling DoS attack variants described above. Methods according to the present disclosure, instead of identifying malicious or hijacked UEs, focus on RRC connection establishment requests. The methods distinguish potentially malicious requests, that may be part of a Signaling DoS attack, using PHY-layer-related information extracted during the initial messages exchanged (PRACH and/or RRC connection REQUEST). This extracted information is at least partially representative of a location of the wireless device that sent the message, for example sufficient to be able to judge physical proximity of the device that sent the message, to devices from which other (reference) suspected malicious RRC connection establishment requests have been sent. This physical proximity will capture both groups of malicious or hijacked UEs or UE identities, and multiple malicious requests sent from a single device in quick succession. It will be appreciated that methods according to the present disclosure, by focusing on malicious requests and not on individual devices, do not depend on availability of a unique identifier for a UE, which is not yet available during the RRC connection establishment procedure. Such methods allow the network to set specific policies for potentially malicious requests in order to preserve access to limited radio resources for benign devices within the same cell. Policies for potentially malicious requests restrict the availability of network connection, for example by withholding an RRC connection SETUP message, or by reducing the probability of sending an RRC connection SETUP message.

### BRIEF DESCRIPTION OF THE DRAWINGS

For a better understanding of the present disclosure, and to show more clearly how it may be carried into effect, reference will now be made, by way of example, to the following drawings in which:

FIG. 1 shows the general outline of the RRC establishment procedure;

FIG. 2 illustrates different variants of signaling DoS attack;

FIG. 3 is a flow chart illustrating process steps in a method for managing connection of wireless devices to a communication network;

FIG. 4 is a flow chart illustrating process steps in another example of a method for managing connection of wireless devices to a communication network;

FIG. 5 is a block diagram illustrating functional modules in an example RAN node;

FIG. 6 is a block diagram illustrating functional modules in another example of RAN node;

FIG. 7 is a flow chart illustrating an example implementation of the method of FIG. 4;

FIG. 8 is a signaling flow illustrating message exchange between a RAN node and a wireless device; and

FIG. 9 is an illustration of two different layer split approaches across a Radio Access Network.

### DETAILED DESCRIPTION

Examples of the present disclosure propose a method and RAN node that can be used to counter the different variants of Signalling DoS attack discussed above, by identifying potentially malicious RRC connection establishment requests using features extracted from PHY layer of either the RRC connection REQUEST message, or a preceding PRACH transmission. The features contain information about a physical location of the device that sent the message, and a separation between the extracted features and reference features may be used to identify potentially malicious requests. The refence features are extracted from messages received in previously uncompleted RRC connection establishment procedures. As discussed above, an incomplete RRC connection establishment procedure is a feature of a Signalling DoS attack that targets this procedure, and is thus a good indication of a malicious request.

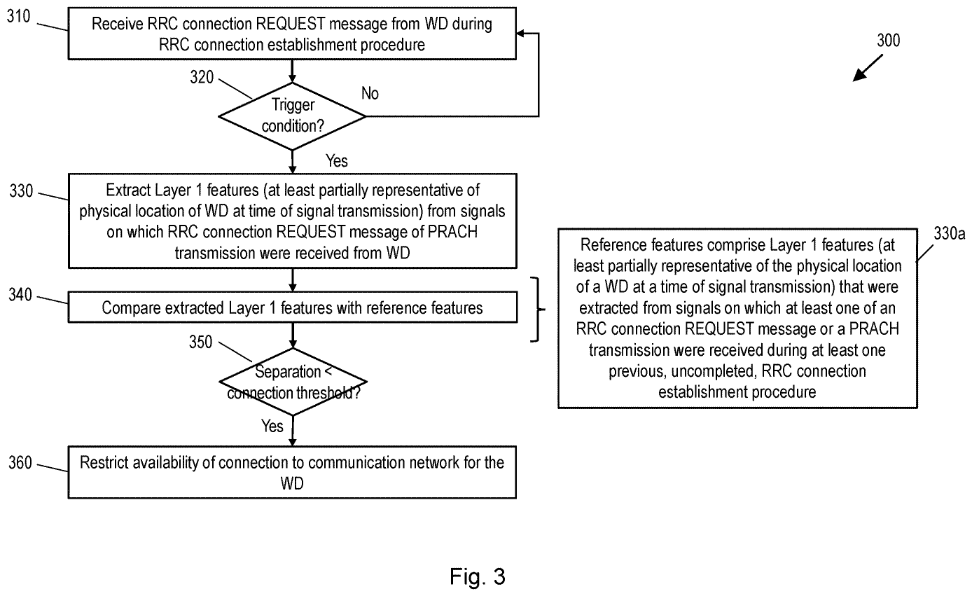

FIG. 3 is a flow chart illustrating process steps in a method 300 for managing connection of wireless devices to a communication network, the communication network comprising a Radio Access Network (RAN). The method is performed by a RAN node of the communication network. A RAN node of a communication network comprises a node that is operable to transmit, receive, process and/or orchestrate wireless signals. A RAN node may comprise a physical node and/or a virtualised network function. In some examples, a RAN node may comprise a NodeB, eNodeB, gNodeB, etc., or any other current or future implementation of such functionality. It will be appreciated that a RAN node may encompass multiple logical elements, some of which may be physical elements such as those involved in the physical transmission and reception of wireless signals, or in the physical processing of such signals, and virtual logical elements. Physical logical elements may be physically separated from each other while still being logically connected, and part of the RAN node. Thus, a RAN node may encompass for example a remote radio antenna and centralised processing equipment. Virtual logical elements may be instantiated in a centralised processing unit, or in a cloud, edge cloud, or fog deployment.

Referring to FIG. 3, in a first step 310, the RAN node receives a Radio Resource Connection (RRC) connection REQUEST message from a wireless device during an RRC connection establishment procedure. The RAN node then considers in step 320 whether or not a trigger condition is fulfilled. If the trigger condition is fulfilled, the RAN node proceeds, in step 330, to extract Layer 1 features, which features are at least partially representative of the physical location of the wireless device at a time of signal transmission, from signals on which at least one of the RRC connection REQUEST message or a Physical Random Access Channel (PRACH) transmission were received from the wireless device. It will be appreciated that for a given received RRC connection REQUEST message, the RAN node is capable of identifying the corresponding PRACH transmission that was received from the same wireless device, even though the RAN node is not yet in a position to uniquely identify that wireless device within the network. It will be appreciated that the extracted Layer 1 features are “at least partially representative” of the physical location of the wireless device at a time of signal transmission. Layer 1 signal features may provide a wide range of information, including for example quality of transmission, signal strength, etc. In some examples, the features extracted at step 330 may be suitable for providing such information, and the present disclosure does not exclude the use of such information contained within the extracted features. However, examples of the present disclosure exploit the intuition that malicious RRC connection requests frequently originate from a location that is in close proximity to locations from which other suspected malicious RRC connection requests originated.

This may be owing to a single device sending multiple malicious RRC connection requests in quick succession, or a group of devices in substantially the same location each sending malicious RRC connection requests. Examples of the present disclosure do not therefore seek to extract features that can enable determination of the exact physical location from which a signal originated, although this may be possible. Rather, rather features are extracted that are at least partially representative of the physical location. Such features thus provide some kind of information about the physical location from which the signal originated, and can be used to identify groups of signals that originate from substantially the same or very similar locations.

In step 340, the RAN node compares the extracted Layer 1 features with reference features. As illustrated at 330a, the reference features comprise Layer 1 features, which features are at least partially representative of the physical location of a wireless device at a time of signal transmission, and were extracted from signals on which at least one of an RRC connection REQUEST message or a PRACH transmission were received during at least one previous, uncompleted, RRC connection establishment procedure. As discussed above, an uncompleted RRC connection establishment procedure is a feature of a Signaling DoS attack that targets this procedure, and is thus a good indication of a malicious request. The reference features are thus extracted from messages that fulfil at least one criterion for being malicious in nature.

In step 350, the RAN node checks whether a separation between the extracted features and at least some of the reference features is below a connection threshold value. The separation may be measured using any metric appropriate to the features, and in some examples, the “at least some” of the reference features may comprise the members of a cluster of reference features, as discussed in greater detail below. If the separation is below a connection threshold value, in step 360 the RAN node restricts an availability of connection to the communication network for the wireless device. This may comprise refusing connection, for example by withholding an RRC connection SETUP message, or may comprise for example reducing the probability of sending such a message. In either implementation, resources available for the RRC connection procedure are prioritized for those RRC connection requests that are not judged to be potentially malicious.

It will be appreciated that, as discussed above, the method 300 makes a distinction between a wireless device and the requests it sends, with access for the wireless device to the network being dependent on features of its RRC connection request message or PRACH transmission. The request is assessed on the basis of Layer 1 features of the transmission signal, meaning there is no need for higher level protocols, and the method can be completed early in the RRC connection process. This is before the device can be identified uniquely in the network, and so earlier than any existing methods for detection of malicious activity.

As discussed in greater detail below, in some examples of the present disclosure, the step of extracting Layer 1 features may be carried out using a Machine Learning (ML) model. For the purposes of the present disclosure, the term “ML model” encompasses within its scope the following concepts:
machine Learning algorithms, comprising processes or instructions through which data may be used in a training process to generate a model artefact for performing a given task, or for representing a real-world process or system; and
the model artefact that is created by such a training process, and which comprises the computational architecture that performs the task.

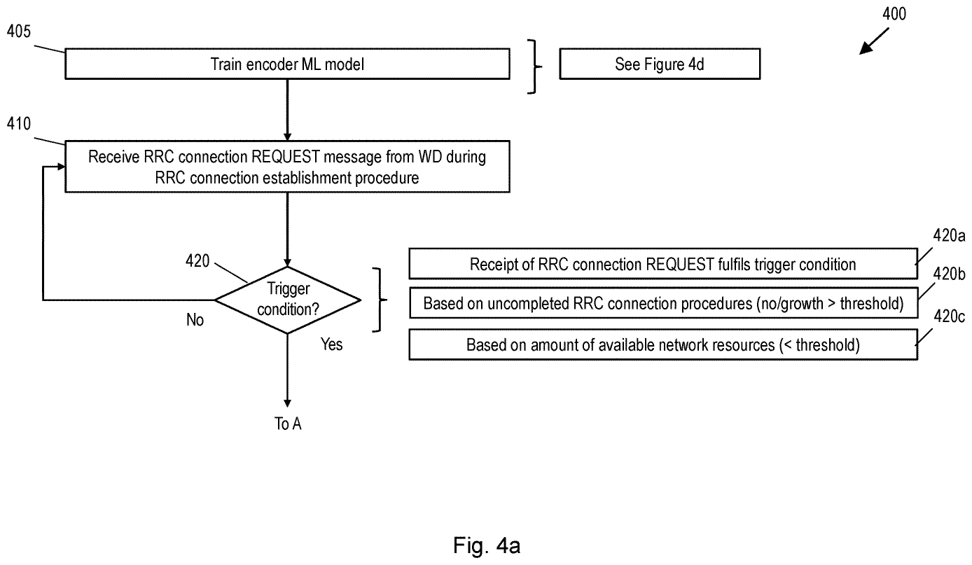

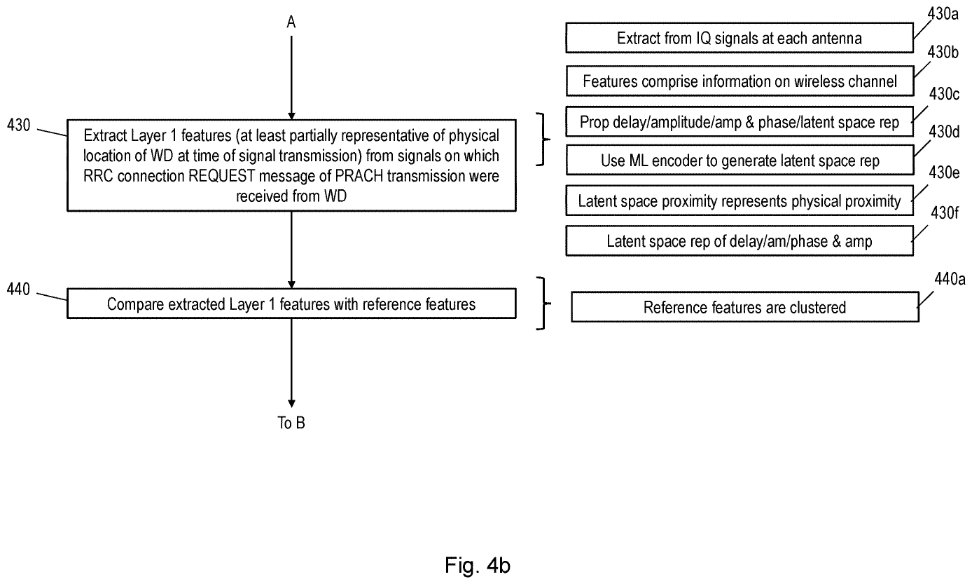

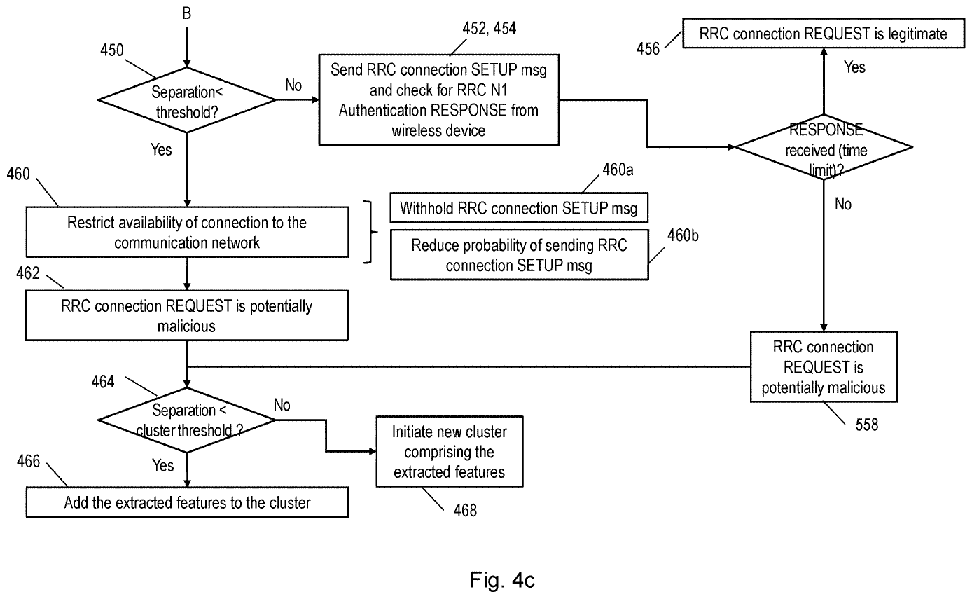

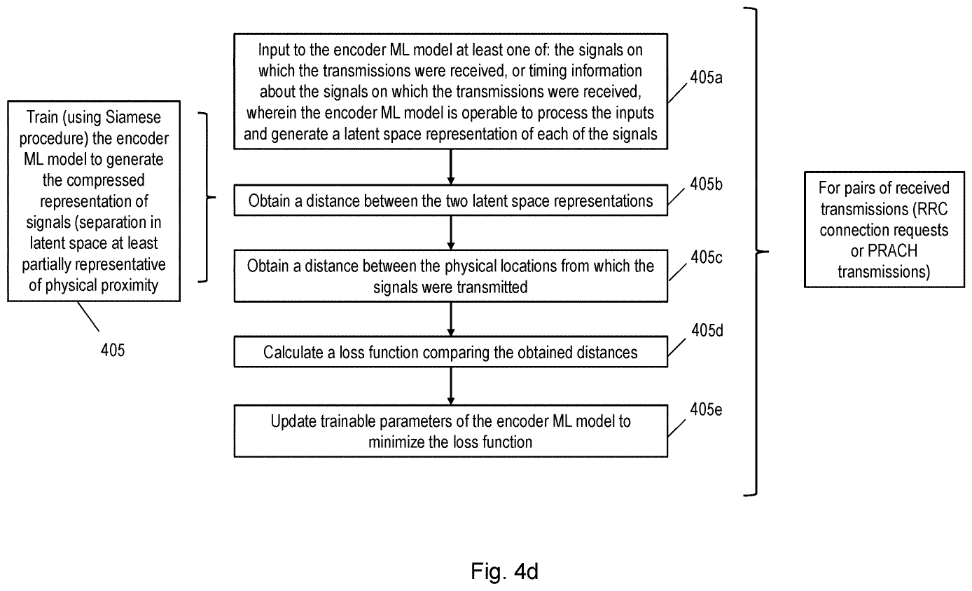

FIGS. 4a to 4d show flow charts illustrating another example of a method 400 for managing connection of wireless devices to a communication network, the communication network comprising a RAN. As for the method 300 discussed above, the method is performed by a RAN node of the communication network. A RAN node of a communication network comprises a node that is operable to transmit, receive, process and/or orchestrate wireless signals, as discussed in greater detail above with reference to FIG. 3. The method 400 illustrates examples of how the steps of the method 300 may be implemented and supplemented to provide the above discussed and additional functionality.

Referring initially to FIG. 4a, in implementations of the method 400 in which an ML model is used for feature extraction, the RAN node carrying out the method 400 may initially train an encoder ML model in a first step 405. Steps that may be performed in order to carry out the training of an encoder ML model at step 405 are illustrated in FIG. 4d, and are discussed in detail below.

In step 410, the RAN node receives an RRC connection REQUEST message from a wireless device during an RRC connection establishment procedure. The RAN node then determines whether or not a trigger condition is fulfilled at step 420. As illustrated at 420a, in some examples of the method 400, receiving an RRC connection REQUEST message may be sufficient to fulfil the trigger condition, meaning the subsequent method steps are carried out on receipt of any and all RRC connection request messages. In other examples, as illustrated at 420b, the trigger condition may be based on at least one of a number of uncompleted RRC connection establishment procedures, and/or an amount of available communication network resources. According to examples of the present disclosure, the term “based on” may be understood to mean that fulfilment of the trigger condition is dependent, at least in part, on fulfilment of a condition relating to a number of uncompleted RRC connection establishment procedures and/or an amount of available communication network resources. In some examples, as illustrated at 420c, fulfilment of the trigger condition is dependent upon at least one of growth or absolute numbers of uncompleted RRC connection procedures exceeding a threshold, and/or available communication network resources falling below a threshold.

Example implementations of the trigger condition thus enable tailoring of when to run the method in full, for example only executing the subsequent method steps when there is a suspicion of a Signaling DoS attack or when the consequences of a Signaling DoS attack would be particularly severe. Either or both of these situations may be indicated by any of a high number of uncompleted RRC connection establishment procedures, fast growth in the number of uncompleted RRC connection establishment procedures, or limited available network resources. It will be appreciated that for any given new RRC connection establishment request, the above discussed trigger condition implementations are consistent with running the method 400 very early, and countering DoS attacks that previously could not be identified owing to the need for a unique UE identifier to track and predict behavior. While the detection of an incomplete RRC connection may be performed by a higher-level protocol, this detection can be carried out before receipt of a new request, meaning that on receipt of a new RRC connection establishment request, a verification as to whether the number of incomplete RRC connection procedures is above a threshold can be performed quickly and without any higher-level protocol or identifier.

If the trigger condition is not fulfilled, the RAN node may return to step 410 and the receipt of a next RRC connection REQUEST message. If the trigger condition is fulfilled, and referring now to FIG. 4b, the RAN node then extracting Layer 1 features, from signals on which at least one of the RRC connection REQUEST message or a PRACH transmission were received from the wireless device in step 430. As discussed above, the extracted features are at least partially representative of the physical location of the wireless device at a time of signal transmission.

As illustrated at 430a, extracting Layer 1 features, at step 430 may comprise extracting the Layer 1 features from in-phase and quadrature (IQ) signals received at each antenna port on which the signals were received. The extracted Layer 1 features may comprise information on a wireless channel on which the signals were received, as illustrated at 430b.

As illustrated at 430c, the extracted Layer 1 features may comprise at least one of:
an estimated signal propagation delay;
an amplitude of receive signals;
an amplitude and phase of IQ signals received by different antennas of a multi-antenna RAN node; and/or
a representation of the signals in a latent space of reduced dimensionality.

The particular information that can be extracted from the different Layer 1 features according to different implementations of step 430, as well as the options for calculating that information from the features, is discussed in detail below with reference to example implementation of the methods 300 and 400.

In some examples, as illustrated at 430d, extracting the Layer 1 features from signals on which at least one of the RRC connection REQUEST message or a PRACH transmission were received from the wireless device may comprise using an ML encoder model to generate a compressed representation of the signals in a latent space of reduced dimensionality. In some maples, the encoder ML model may comprise a Neural Network (NN), and may have been trained in step 405 as discussed in further detail below.

As illustrated at 430e, for examples in which the encoder ML model is used for feature extraction, proximity between representations of signals in the latent space of reduced dimensionality may be at least partially representative of physical proximity, at the time the signals were transmitted, between wireless devices that transmitted the signals. It will be appreciated that the latent space representation may be agonistic to the precise location from which the wireless device that transmitted the signals, instead providing a representation of the physical proximity of locations from which represented signals were transmitted. The latent space may include representations of signals that were transmitted from multiple different wireless devices, and/or may include representations of multiple signals transmitted from the same wireless device. If the wireless device that transmitted multiple represented signals is in the same physical location when transmitting the signals, then the representations of these signals may be in substantially the same location in the latent space. However, if the wireless device that transmitted multiple represented signals changes its physical location between transmissions, then the physical proximity of the locations from which the signals were transmitted will be reflected in the proximity between the representations of the signals in the latent space. The relative distance between representations of signals in the latent space may therefore be similar to, proportional to, or in some other way related to the relative physical distance between UEs at the time they transmitted the signals.

In some examples, above implementations of the extraction step may be combined, for example by extracting from the signals at least one of:
an estimated signal propagation delay;
an amplitude of receive signals; and/or
an amplitude and phase of IQ signals received by different antennas of a multi-antenna RAN node;
   and generating a representation of the extracted signal propagation delay, amplitude and/or amplitude and phase in a latent space of reduced dimensionality, for example by inputting the extracted signal propagation delay, amplitude and/or amplitude and phase to the encoder ML model discussed above.

In step 440, the RAN node compares the extracted Layer 1 features with reference features. As discussed above, the reference features comprise Layer 1 features, which features are at least partially representative of the physical location of a wireless device at a time of signal transmission, and were extracted from signals on which at least one of an RRC connection REQUEST message or a PRACH transmission were received during at least one previous, uncompleted, RRC connection establishment procedure.

As illustrated at 440a, the reference features may be clustered according to a proximity between the physical locations of which they are at least partially representative. In this manner, features extracted from signals that originated from locations in close physical proximity to each other may be members of the same cluster.

In some examples of the method 400, comparing the extracted and reference features may comprise determining a separation between the extracted features in the latent space and a representative location in the latent space for the cluster (such as the centroid of the cluster). as discussed above, malicious RRC connection requests are generally associated with an RRC connection establishment procedure that is not completed, and may be sent as one of many requests that are received within a short space of time from a device and/or from several devices in close proximity to each other. In either case, extracted features from such requests will appear in the same request cluster, as a device sending many requests in quick succession will generally not have time to change locations between the sending of each request. The reference features extracted from messages associated with uncompleted RRC connection establishment procedures, meaning comparison to a cluster of reference features ensures comparison to previous requests that have a high probability of being malicious.

Referring now to FIG. 4c, in step 450, the RAN node determines whether or not a separation between the extracted features and at least some of the reference features is below a connection threshold value. In examples in which the reference features are clustered, the “at least some” of the reference features may comprise the members of any one or more of the clusters of reference features.

If the separation between the extracted features and at least some of the reference features is below a connection threshold value, the RAN node proceeds in step 460 to restrict an availability of connection to the communication network for the wireless device. Restricting an availability of connection to the communication network for the wireless device may comprises at least one of withholding an RRC connection SETUP message for the wireless device, as illustrated at 460a, or reducing a probability of sending an RRC connection SETUP message to the wireless device, as illustrated at 460b.

In some examples of the method 400, there may exist for example first and second connection thresholds, so that if the separation is below a first (higher) connection threshold value, then the probability of sending an RRC connection SETUP message is reduced, while of the separation is below a second (lower) connection threshold value, then the RRC connection SETUP message is withheld. In this manner, the policy to be adopted with respect to allowing connectivity for the wireless device sending an RRC connection REQUEST message may be adapted according to the separation of extracted message features from reference features, and consequently the likelihood that the message is part of a Signaling DoS attack.

As discussed above, in some examples of the method 400, receiving an RRC connection REQUEST message is sufficient to fulfil the trigger condition, and consequently the subsequent steps of the method 400 may be carried out for all received RRC connection REQUEST messages. In such examples, having determined that the separation between the extracted features and at least some of the reference features is below the connection threshold value and taken the appropriate action at step 460, the RAN node may, at step 462, label the extracted features as belonging to a potentially malicious RRC connection REQUEST message.

In step 464, the RAN node may determine whether or not the separation between the extracted features and the members of any of the clusters of reference features is below a cluster threshold value. If the separation is below a cluster threshold value, the RAN node may add the extracted features to the cluster at step 466. If the separation between the extracted features and the members of any of the clusters of reference features is at or above the cluster threshold value, the RAN node may initiate a new cluster comprising the extracted features at step 468.

Referring again to step 450, if the RAN node determines that the separation between the extracted features and at least some of the reference features is at or above the connection threshold value, in step 452 the RAN node sends an RRC connection SETUP message to the wireless device. In step 454, the RAN node then checks for an RRC N1 Authentication RESPONSE message from the wireless device, and, if an RRC N1 Authentication RESPONSE message is received from the wireless device, the RAN node determines in step 456 that the received RRC connection REQUEST message is legitimate. If the request is legitimate, this may prompt the RAN node to discard the extracted features. In other examples, the RAN node may label the extracted features as belonging to a completed, and consequently legitimate, request.

If an RRC N1 Authentication RESPONSE message is not received from the wireless device within a time limit, the RAN node may determine, at step 458, that the received RRC connection REQUEST message is potentially malicious. The RAN node may then retain the extracted features, may label them as belonging to a potentially malicious request, and may add them to the relevant cluster or use them to start a new cluster, as discussed above.

As discussed above, at the beginning of method 400 in a first step 405, the RAN node performing the method 400 may initially train an encoder ML model for use in the feature extraction of step 430. FIG. 4d illustrates sub steps that may be carried out by the RAN node in order to perform the step 405 of training the encoder ML model.

Referring to FIG. 4d, the training at step 405 comprises training the encoder ML model to generate a compressed representation of signals in a latent space of reduced dimensionality such that proximity between representations of signals in the latent space of reduced dimensionality is at least partially representative of physical proximity, at the time the signals were transmitted, between wireless devices that transmitted the signals. As illustrated in step 405, training the encoder ML model may comprise using a Siamese procedure. The training step 405 may be carried out before or after deployment, and in some examples, the encoder ML model may be refined post deployment, following initial pre deployment training.

As illustrated in FIG. 4d, the training step 405 may comprise performing steps 405a to 405e for pairs of received transmissions. The pairs of received transmissions may comprise at least one of (i) pairs of RRC connection REQUEST messages, or (ii) pairs of PRACH transmissions. In step 405a, the RAN node inputs to the encoder ML model at least one of: the signals on which the transmissions were received, or timing information about the signals on which the transmissions were received, wherein the encoder ML model is operable to process the inputs and generate a latent space representation of each of the signals. The signals may be IQ signals, and the timing information may comprise signal arrival time for all antennas and/or signal transmission time. In step 405b, the RAN node obtains a distance between the two latent space representations, and in step 405c, the RAN node obtains a distance between the physical locations from which the signals were transmitted. Options for obtaining the physical locations may include GPS and/or network-based localization methods. The distance measures may comprise physical distance between the obtained physical locations, and some suitable distance measure for the latent space, such as Euclidean distance. The RAN node then calculates a loss function comparing the obtained distances in step 405d, and updates trainable parameters of the encoder ML model to minimize the loss function in step 405e. Steps 405a to 405e may be repeated for different pairs of transmissions until convergence.

As discussed above, the methods 300 and 400 may be performed by a RAN node, and the present disclosure provides a RAN node that is adapted to perform any or all of the steps of the above discussed methods. The RAN node may comprise a physical node such as a computing device, server etc., and/or may comprise a virtual node. A virtual node may comprise any logical entity, such as a Virtualized Network Function (VNF) which may itself be running in a cloud, edge cloud or fog deployment. The RAN node may in some examples comprise both physical and virtual elements. At least some parts of the RAN node may be operable to be instantiated in a cloud based deployment.

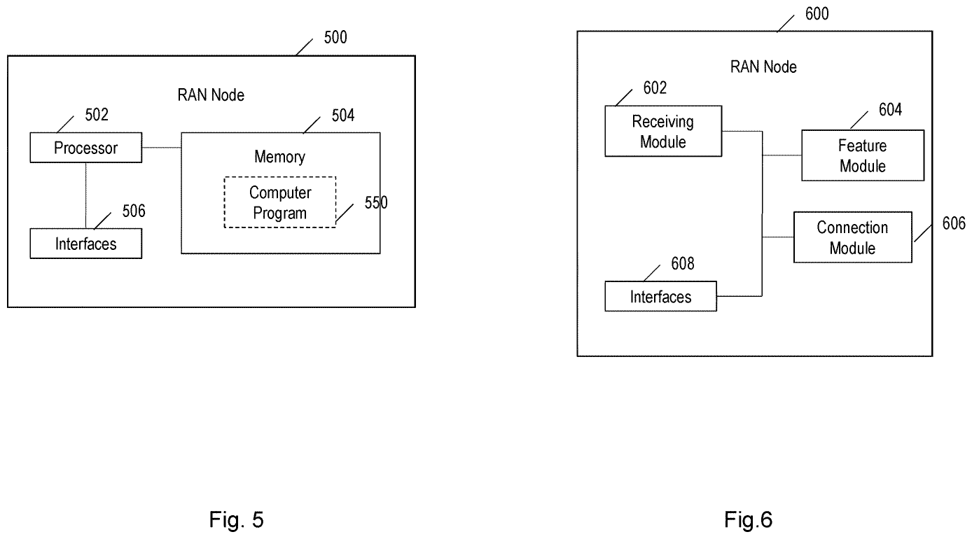

FIG. 5 is a block diagram illustrating an example RAN node 500 which may implement the method 300 and/or 400, as illustrated in FIGS. 3 and 4a to 4d, according to examples of the present disclosure, for example on receipt of suitable instructions from a computer program 550. Referring to FIG. 5 the RAN node 500 comprises a processor or processing circuitry 502, and may comprise a memory 504 and interfaces 506. The processing circuitry 502 is operable to perform some or all of the steps of the method 300 and/or 400 as discussed above with reference to FIGS. 3 and 4a to 4d. The memory 504 may contain instructions executable by the processing circuitry 502 such that the RAN node 500 is operable to perform some or all of the steps of the method 300 and/or 400, as illustrated in FIGS. 3 and 4a to 4d. The instructions may also include instructions for executing one or more telecommunications and/or data communications protocols. The instructions may be stored in the form of the computer program 550. In some examples, the processor or processing circuitry 502 may include one or more microprocessors or microcontrollers, as well as other digital hardware, which may include digital signal processors (DSPs), special-purpose digital logic, etc. The processor or processing circuitry 502 may be implemented by any type of integrated circuit, such as an Application Specific Integrated Circuit (ASIC), Field Programmable Gate Array (FPGA) etc. The memory 504 may include one or several types of memory suitable for the processor, such as read-only memory (ROM), random-access memory, cache memory, flash memory devices, optical storage devices, solid state disk, hard disk drive, etc. The RAN node may further comprise interfaces which may be operable to facilitate communication with other nodes and/or wireless devices over suitable communication channels.

FIG. 6 illustrates functional modules in another example of RAN node 600 which may execute examples of the methods 300 and/or 400 of the present disclosure, for example according to computer readable instructions received from a computer program. It will be understood that the modules illustrated in FIG. 6 are functional modules, and may be realized in any appropriate combination of hardware and/or software. The modules may comprise one or more processors and may be integrated to any degree.

Referring to FIG. 6, the RAN node 600 is for managing connection of wireless devices to a communication network, wherein the communication network comprises a RAN. The RAN node comprises a receiving module 602 for receiving an RRC connection REQUEST message from a wireless device during an RRC connection establishment procedure. The RAN node further comprises a feature module 604 for, if a trigger condition is fulfilled, extracting Layer 1 features, which features are at least partially representative of the physical location of the wireless device at a time of signal transmission, from signals on which at least one of the RRC connection REQUEST message or a PRACH transmission were received from the wireless device. The feature module 604 is also for comparing the extracted Layer 1 features with reference features.

The RAN node further comprises a connection module 606 for, if a separation between the extracted features and at least some of the reference features is below a connection threshold value, restricting an availability of connection to the communication network for the wireless device, wherein the reference features comprise Layer 1 features, which features are at least partially representative of the physical location of a wireless device at a time of signal transmission, and were extracted from signals on which at least one of an RRC connection REQUEST message or a PRACH transmission were received during at least one previous, uncompleted, RRC connection establishment procedure. The RAN node 600 may further comprise interfaces 608, which may be operable to facilitate communication with other nodes or modules, and or with wireless devices, over suitable communication channels.

FIGS. 3 to 4d discussed above provide an overview of methods which may be performed according to different examples of the present disclosure. These methods may be performed by a RAN node as illustrated in FIGS. 5 and 6. The methods enable the detection and countering of Signalling DoS attacks during the RRC connection establishment procedure. There now follows a detailed discussion of how different process steps illustrated in FIGS. 3 to 4d and discussed above may be implemented. The functionality and implementation detail described below is discussed with reference to the modules of FIGS. 5 and 6 performing examples of the methods 300 and/or 400, substantially as described above.

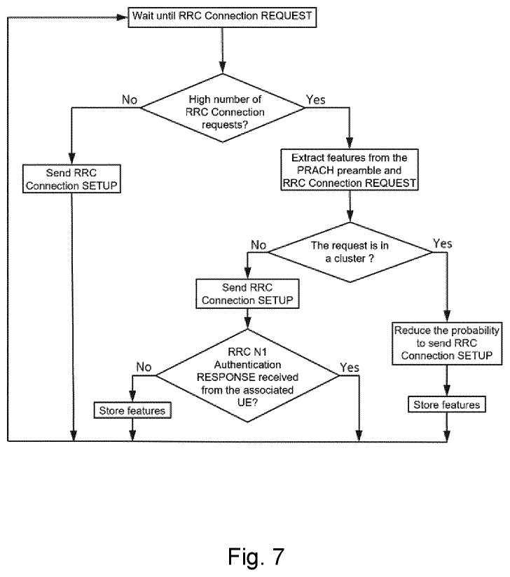

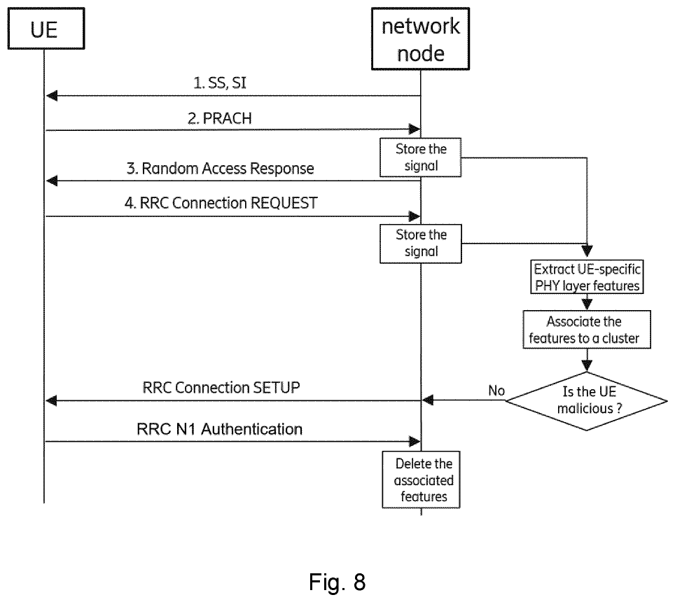

FIG. 7 is a flow chart illustrating an example implementation of the method 400, and FIG. 8 is a signaling flow illustrating message exchange between a RAN node (network node) implementing the example of FIG. 7 and a wireless device (UE).

The example implementation of FIGS. 7 and 8 is discussed below, with reference to the method steps of the methods 300 and 400.

Step 1 (Steps 310, 410, 320, 420 of the methods 300, 400): Upon reception of an RRC Connection REQUEST message, the network node (RAN node) checks fulfilment of the trigger condition by evaluating whether there are a large number of unaccomplished or failed RRC connection requests occurring within a given cell or cellular notification area.

In some examples, this condition may be evaluated by determining whether the number of requests that have not completed the initial RRC message exchange is larger than a first pre-determined threshold and/or there has been a relative growth larger than a second pre-determined threshold. In some examples, this condition may be evaluated by determining if the number of available network resources is lower than a pre-determined threshold.

Step 2 (Steps 330, 430, 430a to 430f of method 300, 400): If the network node determines that the trigger condition is fulfilled for example there are a large number of devices that have not completed the initial RRC message exchange, then it extracts Layer 1 (PHY layer) signal features from the PRACH preamble (sent prior to the RRC signaling as shown in FIG. 8) and/or the RRC Connection REQUEST transmissions. The extracted features are specific to the particular transmission, and so to the characteristics, position, and/or state of the wireless device (UE) sending the transmission, at the time the transmission was sent. Specifically, the network node may extract the features from in-phase and quadrature (IQ) signals from each antenna port available at the PHY layer of NR-compliant systems. It will be appreciated that the methods 300, 400, do not require the higher-layer information contained in the messages sent by the UE (for example, the UE identifier contained in the random access preamble) only using the Layer 1 characteristics of the signals, including for example time information.

It will be understood that the IQ signals contain information on the wireless channel between the network node and the UE that transmitted the RRC connection request, including for example the signal propagation delay. Intuitively, the signal propagation delay can be estimated by the network node by comparing the time of arrival of the signal with the known and specified time of transmission. If the network node is equipped with an antenna array, channel angular and strength information may also be extracted from these IQ signals. This type of information contained in the IQ signals can be used to identify the request, for example in a latent space representation, and differentiate it from other requests generated by UEs in different physical locations.

In a first set of examples, the PHY signal features to be extracted may comprise the following:

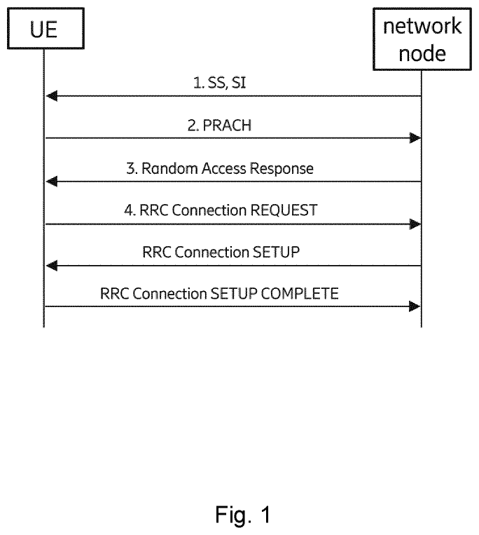

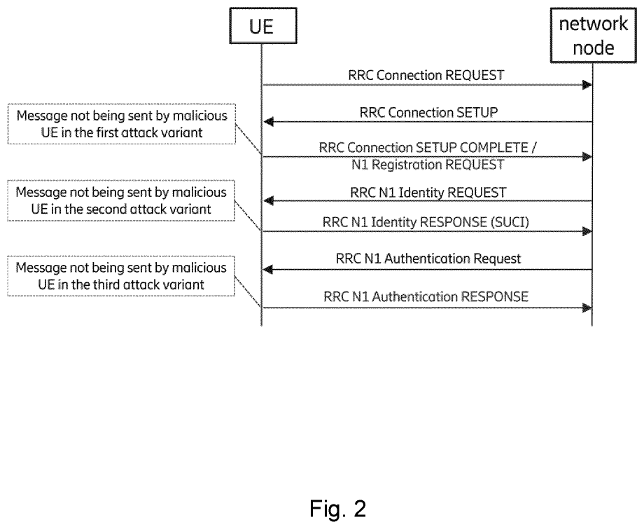

The estimated signal propagation delay: this feature captures information about the distance between the UE and the network node. This delay is already computed by the network nodes to allow a better time synchronization, i.e., via the transmission of the timing advance value field contained within the random access response message (see FIG. 1). While there exists a variety of procedures to compute this delay, all of them leverage both a) the knowledge of when the PRACH message was sent, as the transmission instant is specified by the network node, and b) the PRACH message arrival time.

The amplitude of the receive signals: this feature captures information about the distance between the UE and the network node and it includes, for example, the I1 and/or I2 norms of the received IQ signals.

For multi-antenna network nodes, the amplitude and the phases of the IQ signals received by different antennas: if there is more than one antenna in the network node, differences in the amplitude and phases of the IQ signals can be used to characterize the angular location of the received signal. For instance, some examples may use i) algorithms for estimating the signal's angle of arrival, and/or ii) the method described in G. Geraci, A. Garcia-Rodriguez, D. López-Pérez, A. Bonfante, L. Galati Giordano and H. Claussen, “Operating Massive MIMO in Unlicensed Bands for Enhanced Coexistence and Spatial Reuse,” IEEE Journal on Selected Areas in Communications, vol. 35, no. 6, pp. 1282-1293 June 2017 to obtain an estimate of the wireless channel covariance matrix from the received signals (i.e., by multiplying the vector of received IQ samples per antenna by its complex conjugate per time/frequency resource element and subsequently averaging across all available time/frequency resource elements).

In a second set of examples, the PHY signal features may be extracted by a Neural Network (NN) encoder that compresses the high-dimensional signals (for example the IQ signals) into a latent space of reduced dimensionality. This facilitates the storage of the features in memory and the subsequent clustering described below. Intuitively, the multi-dimensional latent space representation will capture the same information captured by the features described in the first set of examples (i.e., channel angle, strength, etc.). The dimensionality of the latent space representation may depend on, factors including a) the memory constraint of the network node, and/or b) the number of antennas at the network node.

In some examples, the NN would be trained before deployment. In other examples, the NN learning and/or finetuning may take place after deployment. Training may be conducted for example using a Siamese procedure to ensure that the distance between two physically close UEs that send RRC request is similar in the latent space. Training with a Siamese procedure is discussed in Chicco, D. Siamese neural networks: an overview, Artificial Neural Networks, 2021. As this training procedure may require information including the physical location of the UE, this location information may be extracted, for example via simulated data, via GPS, and/or via network-based localization methods.

During a training or learning phase, the inputs to the NN may be processed pairwise, a pair of inputs at a time, each derived from two distinct RRC requests or PRACH transmissions that have been received. Each of the inputs may comprise i) the IQ signals received in all antennas, ii) the signal arrival time for all the antennas, and/or iii) the known signal transmission time. In some examples in which the NN uses information about the physical localization of the UE, the location information may be extracted for example via simulated data, via GPS, and/or via network-based localization methods. The output of the NN will be a latent space representation of the input signals.

During training the IQ signals of two RRC requests or two PRACH transmissions are passed through the NN, which provides two vectors representing the requests in the latent space. In some examples, the passing may be performed consecutively in time. Subsequently, a loss function (for example, square difference) compares i) the Euclidean distance in the latent space between the two latent space representations with ii) the physical distance between the two UEs that transmitted the IQ signals. The weights of the NN are updated based on the calculated loss function, for instance via gradient descent. This procedure is repeated with different RRC request pairs and/or PRACH transmission pairs until convergence. As the loss function compares the two distances, the learning procedure ensures that two RRC requests or two PRACH transmissions from a similar location are close in the latent space.

During inference, the NN receives as input a single RRC request or PRACH transmission, and the output of the NN will be a latent space representation of the input signal.

In a third set of examples, the above mentioned first and second examples sets may be combined. For example, the inputs to the NN encoder included in the second set of embodiments may be the output of the UE-specific PHY signal features produced in the first set of embodiments (i.e., input pre-processing).

Step 3 (steps 340 to 360 and 440 to 468 of methods 300 and 400): The network node compares a) the PHY signal features extracted from the transmission, with b) clustered PHY signal features of previous RRC connection processes that were not completed. If the distance between a) and b) is smaller than a given threshold, the RRC connection REQUEST is determined to be malicious. This may be as a result of having been sent by a malicious UE, or by a hijacked UE. The network node may then either simply not send the RRC connection SETUP message, or may reduce the probability of sending the RRC connection SETUP message. In so doing, the network node prioritizes available resources for UEs that are considered to have sent legitimate, non-malicious requests. If the distance between a) and b) is at or above the given threshold, the network node will transmit the RRC connection SETUP message.

Malicious or hijacked UEs may send several RRC connection requests in a small amount of time and/or may be located physically close to each other. In both cases, there will be several requests close to each other in the latent space representation, and so a new request that is close in the latent space representation to a cluster of requests associated with previous, incomplete, RRC connection procedures, is highly likely to be malicious.

As discussed above, if the distance between a) and b) is smaller than a given threshold, the UE may not be allowed to join the network, that is, the network node may choose not to transmit the RRC connection SETUP message. In other examples, if the distance between a) and b) is smaller than a given threshold, the network node may reduce the probability of sending the RRC request SETUP message. The probability may depend on, for example, the number of points in the relevant cluster, the distance between a) and b) and/or the number of available resources. In further examples, the network node may employ two thresholds, to ensure that network access is denied to requests most likely to be malicious, with probability reduction being used for remaining suspected malicious requests.

The network node may also add the extracted features to a cluster for future evaluation of newly received requests, or may start a new cluster. For example, if the distance between a new point and a centroid cluster is smaller than a fixed value R, the network node may add the new point to the relevant cluster. Otherwise, the network node may create a new cluster. In some examples, the network may add a new point only for a fixed period of time T.

Step 4 (steps 454 to 458 of method 400): If the network node transmitted the RRC Connection SETUP message in Step 3, the network node may monitor for receipt of the relevant RRC N1 Authentication RESPONSE message from the UE. In some examples, if the network node does not receive the RRC N1 Authentication RESPONSE message, it may consider the UE as potentially malicious and store the above-described PHY signal features of the UE's transmissions. If the network node receives RRC N1 Authentication RESPONSE message, the network node removes the point in the feature space and possibly the associated cluster if no more points are related to this cluster.

In some examples, the network node may store all the points in the feature space, using labels to indicate whether or not the relevant UE sent its RRC N1 Authentication RESPONSE message.

### Example Implementation Architecture

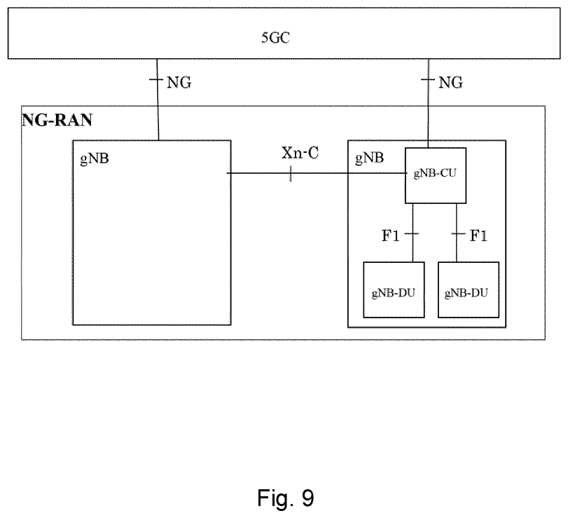

Depending on the layer split across the Radio Access Network, the methods presented herein can be implemented in at least two different ways. FIG. 9 is an illustration of two different layer split approaches across the Radio Access Network. On the left of FIG. 9 is a gNB with Monolithic RAN compute, and on the right is a gNB with Higher Layer Split architecture.

In monolithic RAN compute (left-hand side of FIG. 9), the methods presented herein may be implemented as a software component that is hosted (or co-located) within a single logical eneity in a network node, for example a gNodeB for 5G NR, or an eNodeB for LTE. The software component may implement the methods described herein, leveraging both RRC protocol information and PHY layer information associated with the Random Access procedures preceding RRC connection REQUEST.

In Higher Layer Split architecture (right-hand side of FIG. 9), execution of the methods presented herein can be distributed over multiple logical entities in a network nodes, in particular the gNB-CU entity, which implements the RRC signaling protocol between the network and the UE, and the gNB-DU entity which implements the MAC protocol that handles the Random Access Channels (RACH). In this implementation, changes to the F1 interface between the gNB-CU and the gNB-DU may be enacted to support the methods. These changes are summarized as follows:

Upon detection of unusual number of failed or unaccomplished RRC connection REQUESTS (cf. Step 1), a new F1AP message may be introduced, enabling the gNB-CU to inform the gNB-DU about the UE F1AP IDs associated with the uncompleted or failed RRC connection requests. Those identifiers may be used by the gNB-DU to extract PHY layer information associated with the potentially malicious RRC connection requests, and subsequently to trigger the clustering (cf. step 2). This new message may include a listing of UE F1AP IDs which are associated with uncompleted or failed RRC connection requests.

A new attribute may be added to the standard message<F1 SETUP REQUEST>, enabling the gNB-DU to inform the gNB-CU that a new F1AP context to be established is associated with a potentially malicious RRC connection REQUEST. The gNB-DU, as per step 3 above, identifies a new malicious request if it belongs to a cluster of malicious connections. This new attribute can be implemented as a normalized value (a real number in the range [0, 1]), in which:
0 refers to a benign connection—i.e., not belonging to any malicious cluster
1 refers to a malicious connection—i.e., high confidence for it to belong to a malicious cluster.
Any real value in the range]0, 1[, which refers to a confidence score that the new connection belongs to a malicious cluster

Example methods according to the present disclosure thus enable the detection of malicious RRC Connection SETUP request messages before authentication of the associated UE has taken place within the network. Methods according to the present disclosure can therefore counter Signaling DoS attacks that target the RRC connection procedure, and are therefore useful in preventing all of the attack variants presented in the Background section. In contrast to the existing methods, the proposed methods do not rely on any higher-layer identification protocol.

Methods according to the present disclosure can identify abnormally high rates of failed RRC connection establishment procedures, and extract PHY-layer-related information during the PRACH and the RRC connection REQUEST stages so as to separate clusters of malicious RRC connection REQUEST from legitimate requests. In some examples, such separation is performed in a latent space that captures the physical proximity of UEs at the time of sending their transmissions. This enables the identification of repeated malicious requests from one or multiple UEs that are physically close to each other. Using methods disclosed herein, a target operator will be able to group together and isolate malicious RRC connection SETUP requests that are contributing to an RRC signaling storm, and set policies as to how to handle those malicious requests in order to preserve access to limited radio resources for benign devices within the same cell.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1.-22. (canceled)

23. A method for managing connection of wireless devices to a communication network that includes a radio access network (RAN), wherein the method is performed by a RAN node and comprises:
receiving a radio resource control (RRC) connection REQUEST message from a wireless device during an RRC connection establishment procedure; and
when a trigger condition is fulfilled, extracting Layer 1 features from signals on which at least one of the RRC connection REQUEST message and a Physical Random Access Channel (PRACH) transmission were received from the wireless device, wherein the Layer 1 features are at least partially representative of a physical location of the wireless device when the wireless device transmitted the signals;
comparing the extracted Layer 1 features with reference Layer 1 features that are at least partially representative of a previous physical location of the wireless device when the wireless device transmitted at least one of the following during a previous RRC connection establishment procedure that was not completed: an RRC connection REQUEST message, and a PRACH transmission; and
when a separation between the extracted Layer 1 features and the reference Layer 1 features is below a connection threshold value, restricting availability of a connection for the wireless device to the communication network.

24. The method of claim 23, wherein restricting availability of a connection for the wireless device comprises at least one of the following:
withholding an RRC connection SETUP message for the wireless device; and
reducing a probability of sending an RRC connection SETUP message to the wireless device.

25. The method of claim 23, wherein one or more of the following applies:
the signals from which the extracted Layer 1 features are extracted are in-phase and quadrature (IQ) signals received at one or more antenna ports available on Layer 1; and
the extracted Layer 1 features include information about a wireless channel on which the signals were received.

26. The method of claim 23, wherein the extracted Layer 1 features include one or more of the following:
an estimated signal propagation delay;
an amplitude of the received signals;
respective amplitudes and phases of the signals received via multiple antennas of the RAN node; and
a representation of the signals in a latent space of reduced dimensionality.

27. The method of claim 26, wherein:
at least one of the following Layer 1 features are extracted from the received signals: the estimated signal propagation delay, the amplitude of the received signals, and the respective amplitudes and phases of the signals received via the multiple antennas of the RAN node; and
the extracted Layer 1 features also include the representation of the signals in the latent space of reduced dimensionality, which is generated based on the at least one other Layer 1 feature extracted from the received signals.

28. The method of claim 26, wherein proximity between representations of signals in the latent space of reduced dimensionality is at least partially representative of physical proximity, at the time the signals were transmitted, between wireless devices that transmitted the signals.

29. The method of claim 26, wherein extracting the Layer 1 features from the signals on which at least one of the RRC connection REQUEST message and the PRACH transmission were received comprises using a Machine Learning (ML) encoder model to generate a compressed representation of the signals in the latent space of reduced dimensionality.

30. The method of claim 29, further comprising training the encoder ML model to generate the compressed representation of signals in a latent space of reduced dimensionality such that proximity between representations of signals in the latent space of reduced dimensionality is at least partially representative of physical proximity, at the time the signals were transmitted, between wireless devices that transmitted the signals.

31. The method of claim 30, wherein training the encoder ML model is based on a Siamese procedure comprising the following operations for each pair of received transmissions:
inputting to the encoder ML model at least one of the following:
the signals on which the pair of transmissions were received, and
timing information about the signals on which the pair of transmissions were received;
processing the inputs to generate respective latent space representations of the pair of transmissions;
obtaining a distance between the respective latent space representations;
obtaining a distance between the physical locations from which the signals were transmitted;
calculating a loss function comparing the obtained distances; and
updating trainable parameters of the encoder ML model to minimize the loss function,
wherein each pair of received transmissions is one of the following: a pair of RRC connection REQUEST messages, or a pair of PRACH transmissions.

32. The method of claim 23, wherein:
the reference Layer 1 features are arranged in clusters according to a proximity between the physical locations of which they are at least partially representative; and
the separation is based on members of any of the clusters of reference Layer 1 features.

33. The method of claim 32, further comprising, when the separation between the extracted Layer 1 features and the members of one or more of the clusters of reference Layer 1 features is below a cluster threshold value, adding the extracted Layer 1 features to the one or more clusters.

34. The method of claim 32, further comprising, when a separation between the extracted Layer 1 features and the members of any of the clusters of reference Layer 1 features is at or above a cluster threshold value, initiating a new cluster comprising the extracted Layer 1 features.

35. The method of claim 23, further comprising:
when the separation between the extracted Layer 1 features and the reference Layer 1 features is at or above the connection threshold value, sending an RRC connection SETUP message to the wireless device;
checking for a responsive RRC N1 Authentication RESPONSE message from the wireless device; and
when the checking indicates that a responsive RRC N1 Authentication RESPONSE message is received from the wireless device, determining that the received RRC connection REQUEST message is legitimate.

36. The method of claim 35, further comprising, when the checking indicates that a responsive RRC N1 Authentication RESPONSE message is not received from the wireless device within a time limit, determining that the received RRC connection REQUEST message is potentially malicious.

37. The method of claim 23, wherein fulfilment of the trigger condition is based on at least one of the following:
one or more of the following exceeding a first threshold: absolute number of uncompleted RRC connection procedures, and growth of uncompleted RRC connection procedures; and
available communication network resources falling below a second threshold.

38. The method of claim 23, wherein:
the trigger condition is fulfilled based on receiving an RRC connection REQUEST message; and
the method further comprises, when the separation between the extracted Layer 1 features and the reference Layer 1 features is below the connection threshold value, associating the extracted Layer 1 features with a potentially malicious RRC connection REQUEST message.

39. Radio access network (RAN) node configured to manage connection of wireless devices to a communication network, wherein the RAN node comprise processing circuitry configured to:
receive a radio resource control (RRC) connection REQUEST message from a wireless device during an RRC connection establishment procedure; and
when a trigger condition is fulfilled, extract Layer 1 features from signals on which at least one of the RRC connection REQUEST message and a Physical Random Access Channel (PRACH) transmission were received from the wireless device, wherein the Layer 1 features are at least partially representative of a physical location of the wireless device when the wireless device transmitted the signals;
compare the extracted Layer 1 features with reference Layer 1 features that are at least partially representative of a previous physical location of the wireless device when the wireless device transmitted at least one of the following during a previous RRC connection establishment procedure that was not completed: an RRC connection REQUEST message, and a PRACH transmission; and
when a separation between the extracted Layer 1 features and the reference Layer 1 features is below a connection threshold value, restrict availability of a connection for the wireless device to the communication network.

40. The RAN node of claim 39, wherein the extracted Layer 1 features include one or more of the following:
an estimated signal propagation delay;
an amplitude of the received signals;
respective amplitudes and phases of the signals received via multiple antennas of the RAN node; and
a representation of the signals in a latent space of reduced dimensionality.

41. The RAN node of claim 39, wherein the processing circuitry is further configured to:
when the separation between the extracted Layer 1 features and the reference Layer 1 features is at or above the connection threshold value, send an RRC connection SETUP message to the wireless device;
check for a responsive RRC N1 Authentication RESPONSE message from the wireless device; and
when the check indicates that a responsive RRC N1 Authentication RESPONSE message is received from the wireless device, determine that the received RRC connection REQUEST message is legitimate.

42. The RAN node of claim 39, wherein fulfilment of the trigger condition is based on at least one of the following:
one or more of the following exceeding a first threshold: absolute number of uncompleted RRC connection procedures, and growth of uncompleted RRC connection procedures; and
available communication network resources falling below a second threshold.
